(19) United States
(12) Patent Application Publication
(10) Pub. No.: US 2023/0056455 A1
(43) Pub. Date: Feb. 23, 2023

(54) OPTICAL WAVEGUIDE ELEMENT, OPTICAL COMMUNICATION APPARATUS, AND METHOD OF ELIMINATING SLAB MODE

(71) Applicant: FUJITSU OPTICAL COMPONENTS LIMITED, Kawasaki-shi (JP)

(72) Inventor: Akira OKA, Kawasaki (JP)

(73) Assignee: FUJITSU OPTICAL COMPONENTS LIMITED, Kawasaki-shi (JP)

(21) Appl. No.: 17/842,977

(22) Filed: Jun. 17, 2022

(30) Foreign Application Priority Data
Aug. 20, 2021 (JP) 2021-134943

(51) Int. Cl. G02B 6/125

(52) U.S. Cl. CPC G02B 6/125; H04B 10/2537

(57) ABSTRACT

A waveguide element includes a first waveguide and a second waveguide. The first waveguide includes a first main rib and a first slab that has a smaller thickness than that of the first main rib and in which a slab mode of light propagates. The second waveguide includes a second main rib that is optically coupled with the first main rib and in which the light propagates, a second slab that has a smaller thickness than that of the second main rib, that is optically coupled with the first slab, and in which the slab mode propagates, and a side rib that has a larger thickness than that of the second slab. The slab mode that propagates through the second slab transitions to the side rib in accordance with travel of the light that propagates in the first main rib and the second main rib.

### CROSS-REFERENCE TO RELATED APPLICATION

This application is based upon and claims the benefit of priority of the prior Japanese Patent Application No. 2021-134943, filed on Aug. 20, 2021, the entire contents of which are incorporated herein by reference.

### FIELD

The embodiments discussed herein are related to an optical waveguide element, an optical communication apparatus, and a method of eliminating a slab mode.

### BACKGROUND

In recent years, an optical device using a substrate-type optical waveguide element that can realize a small-sized optical communication apparatus is actively developed. The substrate-type optical waveguide element allows an optical signal to propagate in an optical waveguide that includes a core that is formed on a substrate and a cladding that covers the core, and is able to realize optical devices with various functions.

In contrast, in the optical waveguide element, due to an influence of sidewall scallops that are generated in the optical waveguide at the time of manufacturing, light that propagates is scattered and a propagation loss occurs. It is preferable to reduce the propagation loss to reduce power consumption of the entire optical communication apparatus.

To cope with this, a rib waveguide is known as a structure for reducing the propagation loss. FIG. 9 is a diagram for explaining an example of a conventional rib waveguide. A rib waveguide 100 illustrated in FIG. 9 includes a core 110 that is formed on a substrate (not illustrated), and an upper cladding 120A and a lower cladding 120B that cover the core 110. The core 110 includes a rib 111 and slabs 112 that are formed on both sides of the rib 111 and that have smaller thicknesses than a thickness of the rib 111. In the rib waveguide 100, areas of side walls are effectively small as compared to, for example, a channel waveguide in which the slabs are not provided, so that an influence of sidewall scallops is reduced and it is possible to reduce a propagation loss.

FIG. 10 is a diagram for explaining an example of a slab mode in the conventional rib waveguide. In the rib waveguide 100, a slab mode of signal light that is guided in the slabs 112 is always present, so that the rib waveguide 100 is a multimode waveguide. The slab mode occurs in a portion, such as a multi-mode interferometer (MMI), a bent waveguide, or a waveguide with sidewall scallops, in which an electric field distribution of a fundamental mode as signal light is discontinued in a light traveling direction.
Patent Literature 1: Japanese Laid-open Patent Publication No. 2017-129834
Patent Literature 2: International Publication Pamphlet No. 2016/092829
Patent Literature 3: International Publication Pamphlet No. 2013/062096
Patent Literature 4: U.S. Unexamined Patent Application Publication No. 2015/0063769

However, in the rib waveguide 100, if the slab mode is input, the slam mode interferes with the fundamental mode as the signal light, so that signal quality of the signal light is degraded.

To cope with this, in the conventional rib waveguide 100, the slabs 112 are subjected to doping, so that the doped slabs 112 absorb the electric field and the propagation loss increases in only the slab mode. As a result, it is possible to eliminate the slab mode without affecting the signal light (fundamental mode) that propagates through the rib 111.

However, in the conventional rib waveguide 100, a doping amount is large when the slabs 112 are subjected to doping, and a process of doping needs to be added, so that a manufacturing process becomes cumbersome.

### SUMMARY

According to an aspect of an embodiment, an optical waveguide element includes a core, a cladding, a first rib waveguide, and a second rib waveguide. The core is formed on a substrate. The cladding covers the core. The first rib waveguide is arranged along a traveling direction of signal light. The second rib waveguide is arranged along the traveling direction of the signal light and is optically coupled with the first rib waveguide. The core of the first rib waveguide includes a first main rib in which the signal light propagates. The core of the first rib waveguide includes a first slab that has a smaller thickness than a thickness of the first main rib and in which a slab mode of the signal light propagates. The core of the second rib waveguide includes a second main rib that is optically coupled with the first main rib and in which the signal light propagates. The core of the second rib waveguide includes a second slab that has a smaller thickness than a thickness of the second main rib, that is optically coupled with the first slab, and in which the slab mode propagates. The core of the second rib waveguide includes a side rib that is formed on one end of the second slab and that has a larger thickness than the thickness of the second slab. The slab mode propagates through the second slab transitions to the side rib in accordance with travel of the signal light that propagates in the first main rib of the first rib waveguide and the second main rib of the second rib waveguide.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of an optical communication apparatus according to a first embodiment;

FIG. 2 is a plan view of an optical waveguide element in which an upper cladding is omitted;

FIG. 3 is a cross-sectional view of the optical waveguide element (first rib waveguide) taken along a line A-A in FIG. 2.

FIG. 4 is a cross-sectional view of the optical waveguide element (second rib waveguide) taken along a line B-B in FIG. 2

FIG. 5 is a diagram for explaining an example of signal light in the first rib waveguide and the second rib waveguide;

FIG. 6 is a diagram for explaining an example of transition of a slab mode in the first rib waveguide and the second rib waveguide;

FIG. 7 is a plan view of an optical waveguide element according to a second embodiment in which an upper cladding is omitted;

FIG. 8 is a plan view of an optical waveguide element according to a third embodiment in which an upper cladding is omitted;

FIG. 9 is a diagram for explaining an example of a conventional rib waveguide; and

FIG. 10 is a diagram for explaining an example of a slab mode in the conventional rib waveguide.

### DESCRIPTION OF EMBODIMENTS

Preferred embodiments of the present invention will be explained with reference to accompanying drawings. The present invention is not limited by the embodiments below. In addition, the embodiments described below may be combined appropriately as long as no contradiction is derived.

### First Embodiment

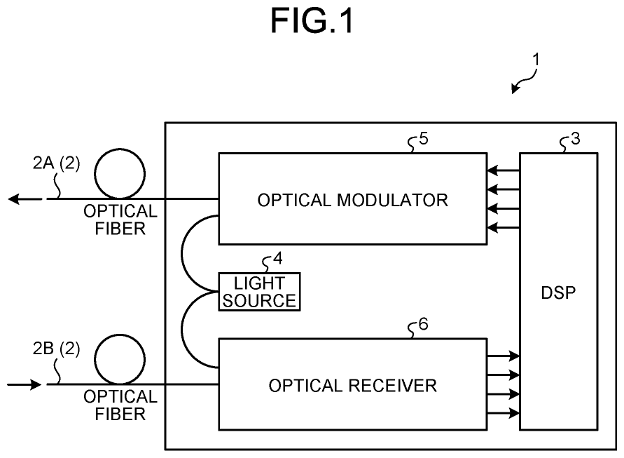

FIG. 1 is a block diagram illustrating an example of an optical communication apparatus 1 according to a first embodiment. The optical communication apparatus 1 illustrated in FIG. 1 is connected to an optical fiber 2A (2) at an output side and an optical fiber 2B (2) at an input side. The optical communication apparatus 1 includes a digital signal processor (DSP) 3, a light source 4, an optical modulator 5, and an optical receiver 6. The DSP 3 is an electrical component that performs digital signal processing. The DSP 3 performs processing, such as encoding, on transmission data, generates an electrical signal including the transmission data, and outputs the generated electrical signal to the optical modulator 5, for example. Further, the DSP 3 acquires an electrical signal including reception data from the optical receiver 6, performs processing, such as decoding, on the acquired electrical signal, and obtains reception data.

The light source 4 includes, for example, a laser diode or the like, generates locally-emitted light at a predetermined wavelength, and supplies the light to the optical modulator 5 and the optical receiver 6. The optical modulator 5 is a communication device that modulates the locally-emitted light supplied from the light source 4 by using the electrical signal output from the DSP 3, and outputs the obtained optical transmission signal to the optical fiber 2A. The optical modulator 5 is an optical device that includes an optical waveguide and a modulation unit. The optical waveguide is formed of a substrate. The optical modulator 5, when the locally-emitted light supplied from the light source 4 propagates in the optical waveguide, modulates the light by the electrical signal that is input to the modulation unit, and generates an optical transmission signal.

The optical receiver 6 is a communication device that includes an optical waveguide and a receiver. The optical receiver 6 receives an optical signal from the optical fiber 2B and demodulates the received optical signal by using the locally-emitted light supplied from the light source 4. Then, the optical receiver 6 converts the demodulated received optical signal into an electrical signal, and outputs the converted electrical signal to the DSP 3.

An optical waveguide element 10 of the present embodiment is, for example, an optical waveguide in the optical modulator 5, an optical waveguide in the optical receiver 6, an optical waveguide between the light source 4 and the optical modulator 5, and an optical waveguide between the light source 4 and the optical receiver 6.

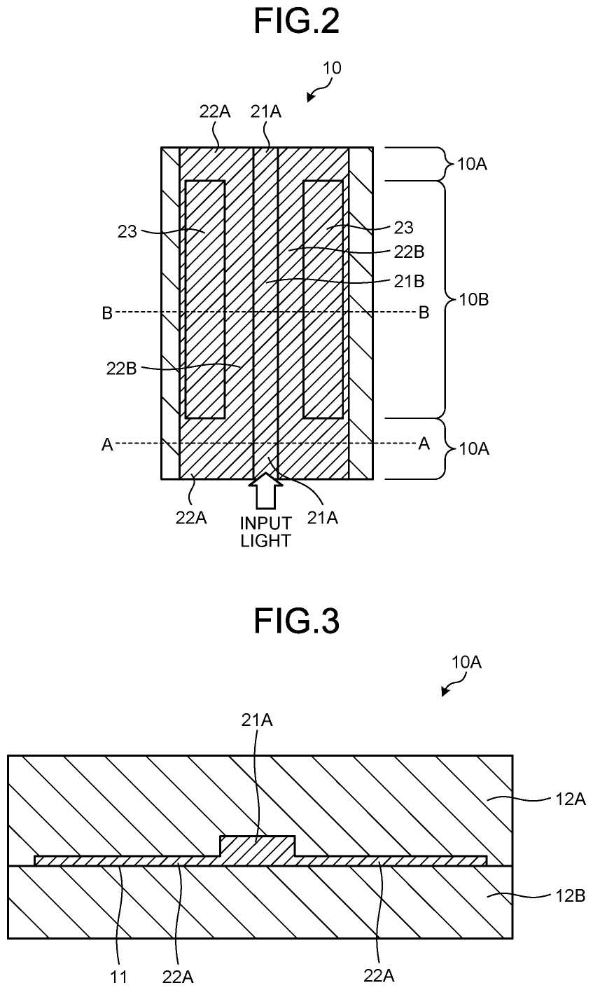

FIG. 2 is a plan view of the optical waveguide element 10 in which an upper cladding 12A is omitted. FIG. 3 is a cross-sectional view of the optical waveguide element 10 (a first rib waveguide 10A) taken along a line A-A in FIG. 2. The optical waveguide element 10 is a rib waveguide that includes a core 11 and the upper cladding 12A and a lower cladding 12B that cover the core 11. The optical waveguide element 10 includes, along a traveling direction of signal light, the first rib waveguide 10A that is arranged on a front stage, a second rib waveguide 10B that is optically coupled with the first rib waveguide 10A, and the first rib waveguide 10A that is arranged on a rear stage and coupled with the second rib waveguide 10B.

The A-A cross-sectional view illustrated in FIG. 3 is a cross-sectional view of the first rib waveguide 10A. The core 11 of the first rib waveguide 10A includes a first main rib 21A and first slabs 22A. The first main rib 21A is a waveguide in which signal light propagates. The first slabs 22A are formed on both sides of the first main rib 21A, and have smaller thicknesses than a thickness of the first main rib 21A. Further, the first slabs 22A are waveguides in which a slab mode of the signal light propagates. Meanwhile, FIG. 3 illustrates the first rib waveguide 10A on the front stage as an example, but the first rib waveguide 10A on the rear stage has the same configuration, and therefore, the same components are denoted by the same reference symbols, and explanation of the same configuration and operation will be omitted. Here, the signal light is, for example, a fundamental mode (TEO or TMO) for which an electric field distribution is locally present in the first main rib 21A. As long as an electric field is locally present in the first main rib 21A, a different higher-order mode may be adopted. Meanwhile, TEO represents a mode for which an effective refractive index is highest among waveguide modes of a rib waveguide in which an electric field component parallel to the substrate serves as a main component, and TMO represents a mode for which an effective refractive index is highest among waveguide modes of a rib waveguide in which an electric field component perpendicular to the substrate serves as a main component. Hereinafter, explanation will be given based on the assumption that TEO is adopted as the signal light.

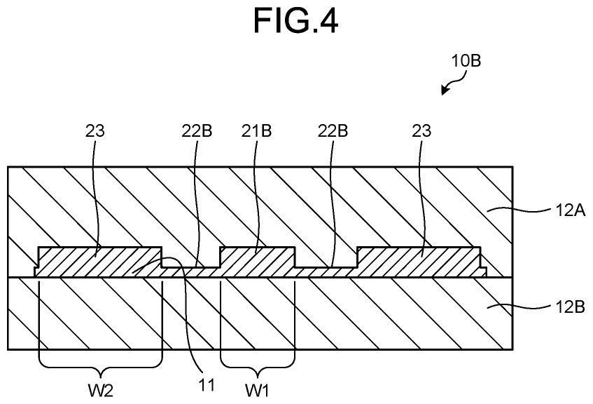

FIG. 4 is a cross-sectional view of the optical waveguide element 10 (the second rib waveguide 10B) taken along a line B-B in FIG. 2. The B-B cross-sectional view illustrated in FIG. 4 is a cross-sectional view of the second rib waveguide 10B. The core 11 of the second rib waveguide 10B includes a second main rib 21B, second slabs 22B, and side ribs 23. The second main rib 21B is a waveguide in which the signal light propagates. The second slabs 22B are formed on both sides of the second main rib 21B and have smaller thicknesses than a thickness of the second main rib 21B. Further, the second slabs 22B are waveguides in which the slab mode of the signal light propagates.

The side ribs 23 are formed on both sides of the second slabs 22B and have larger thicknesses than thicknesses of the second slabs 22B. Further, each of the side ribs 23 is a waveguide to which the slab mode that propagates in the second slabs 22B transitions. A waveguide width W2 of each of the side ribs 23 is set to be larger than a waveguide width W1 of the second main rib 21B. Meanwhile, if the waveguide width W2 of each of the side ribs 23 and the waveguide width W1 of the second main rib 21B are set to the same, the side ribs 23 and the second main rib 21B have functions as directional couplers, so that the signal light that propagates in the second main rib 21B transitions to the side ribs 23. Further, if the waveguide width W2 of each of the side ribs 23 is smaller than the waveguide width W1 of the second main rib 21B, discontinuity of the second slabs 22B is reduced, so that efficiency is reduced. Therefore, the waveguide width W2 of each of the side ribs 23 is set to be larger than the waveguide width W1 of the second main rib 21B.

In other words, the signal light is discontinued between the first rib waveguide 10A and the second rib waveguide 10B because of presence and absence of the side ribs 23. The slab mode that propagates in the second slabs 22B transitions to the side ribs 23 in accordance with travel of the signal light between the first rib waveguide 10A and the second rib waveguide 10B. As a result, only the slab mode is scattered and eliminated due to transition of the slab mode to the side ribs 23.

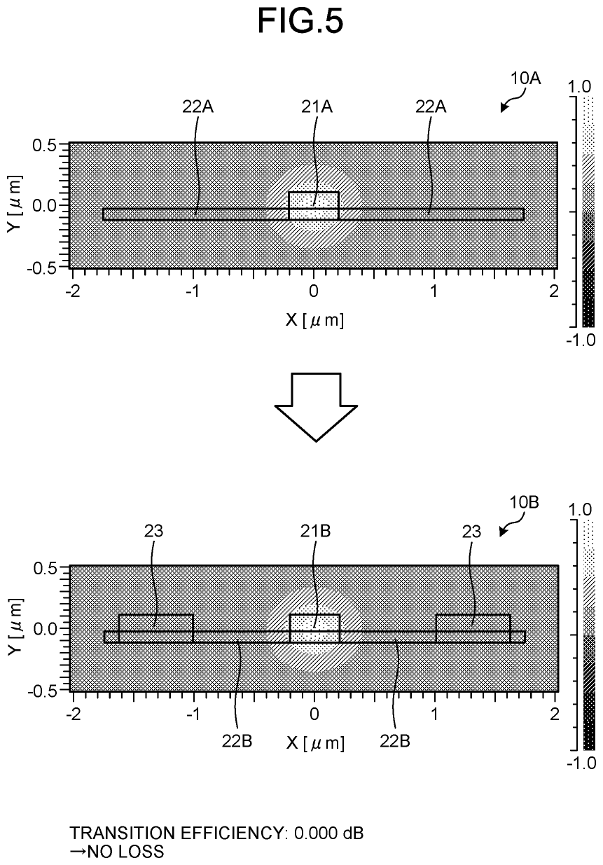

FIG. 5 is a diagram for explaining an example of the signal light in the first rib waveguide 10A and the second rib waveguide 10B. There is no difference between a propagation loss of the signal light that propagates in the first main rib 21A without the side ribs 23 and a propagation loss of the signal light that propagates through the second main rib 21B with the side ribs 23. A distance between the second main rib 21B and each of the side ribs 23 is fully ensured, so that transition efficiency of the signal light is 0.000 dB.

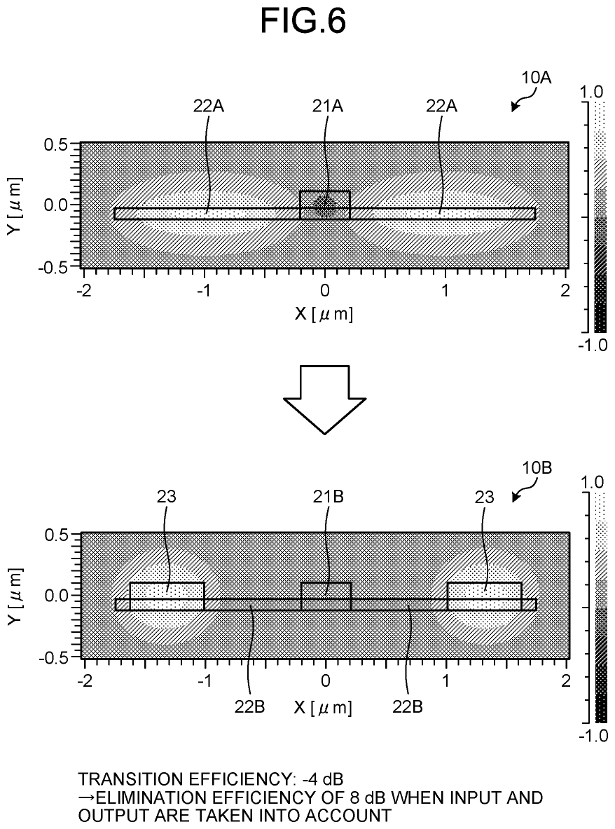

FIG. 6 is a diagram for explaining an example of transition of the slab mode in the first rib waveguide 10A and the second rib waveguide 10B. The slab mode that propagates in the first slabs 22A without the side ribs 23 and the slab mode that propagates in the second slabs 22B with the side ribs 23 are compared. When the slab mode propagates in the second slabs 22B with the side ribs 23, the slab mode transitions to the side ribs 23, so that it is possible to eliminate the slab mode from the second slabs 22B. As illustrated in FIG. 2, transition efficiency of the slab mode from the first rib waveguide 10A on the front stage to the second rib waveguide 10B is −4 dB, and transition efficiency of the slab mode from the second rib waveguide 10B to the first rib waveguide 10A on the rear stage is −4 dB. Therefore, two portions are present as portions in which the signal light is discontinued, such as a portion from the first rib waveguide 10A on the front stage to the second rib waveguide 10B and a portion from the second rib waveguide 10B to the first rib waveguide 10A on the rear stage, so that elimination efficiency of the slab mode is 8 dB.

Therefore, with respect to the signal light, there is no propagation loss regardless of whether the side ribs 23 are present or not, but with respect to the slab mode, a propagation loss increases when the side ribs 23 are present, and therefore it is possible to eliminate the slab mode.

In the optical communication apparatus 1, the slab mode transitions to the side ribs 23 and the slab mode is eliminated, so that it is possible to prevent an influence of the slab mode on the signal light and prevent degradation of the signal quality due to a mode interference. Meanwhile, the degradation of the signal quality due to the mode interference indicates that, for example, a part of the fundamental mode used to cause the signal light to propagate is converted to the slab mode in the middle of a propagation path, and after the propagation is performed for a while, the slab mode is converted to the fundamental mode again. At this time, the fundamental mode interferes, with a phase difference, with the fundamental mode that propagates without being converted to the slab mode, but the phase difference is dependent on a wavelength, and therefore, a degree of interference varies depending on the wavelength. In other words, optical power of the fundamental mode varies depending on the wavelength. Variation of the optical power with a change in the wavelength indicates degradation of the signal quality in the optical communication apparatus 1, which is not preferable.

The first main rib 21A and the second main rib 21B in which the signal light propagates are not subjected to doping in order to prevent an excessive loss of the signal light. However, doping with a single dopant, which is performed to adjust electrical characteristics of the core 11 and for which an optical loss is small enough to be ignored, may be performed. A doping amount at this time is set such that, in a case where the thicknesses of the first main rib 21A and the second main rib 21B are 220 nanometers (nm), a resistance rate is 100 Ωcm or less.

The thicknesses of the side ribs 23 are set to the same as the second main rib 21B in which the signal light propagates, and therefore, the side ribs 23 and the second main rib 21B can easily be formed because they can be collectively formed by lithography/etching.

The core 11 of the first rib waveguide 10A of the optical waveguide element 10 of the first embodiment includes the first main rib 21A and the first slabs 22A. Further, the core 11 of the second rib waveguide 10B includes the second main rib 21B, the second slabs 22B, and the side ribs 23. Furthermore, in the optical waveguide element 10, the slab mode that propagates in the second slabs 22B transitions to the side ribs 23 in accordance with travel of the signal light between the first rib waveguide 10A and the second rib waveguide 10B. As a result, a portion in which the signal light is discontinued is present between the first rib waveguide 10A and the second rib waveguide 10B, so that it is possible to eliminate the slab mode even without performing high-density doping as in the conventional technology.

The side ribs 23 are formed on the second slabs 22B, and cause the slab mode in the second slabs 22B to perform transition in a discontinued manner. As a result, it is possible to form a portion in which the signal light is discontinued between the first rib waveguide 10A and the second rib waveguide 10B. Further, only a mode (side rib mode) and the slab mode that propagates in the side ribs 23 that are transition destinations are scattered and eliminated.

The waveguide width W2 of each of the side ribs 23 is set to be larger than the waveguide width W1 of the second main rib 21B. As a result, it is possible to ensure the discontinuity of the second slabs 22B while preventing the signal light propagating through the second main rib 21B to transition to the side ribs 23.

Meanwhile, for convenience of explanation, the case has been illustrated in which the side ribs 23 are formed on the both sides of the second slabs 22B, but, for example, it may be possible to form the side rib 23 on only one side of the second slabs 22B, and appropriate change is applicable.

Further, the case has been illustrated in which the side ribs 23 are formed on the both sides of the second slabs 22B in a bilaterally symmetric manner, but it may be possible to form the side ribs 23 in a bilaterally asymmetric manner, and appropriate change is applicable.

The case has been illustrated in which a silicon optical waveguide is used in which the core 11 is made of silicon and the upper cladding 12A and the lower cladding 12B are made of SiO₂. However, the technology is applicable to a planar light wave circuit (PLC), an InP waveguide, and a GaAs waveguide in which the core 11, the upper cladding 12A, and the lower cladding 12B are made of SiO₂.

### Second Embodiment

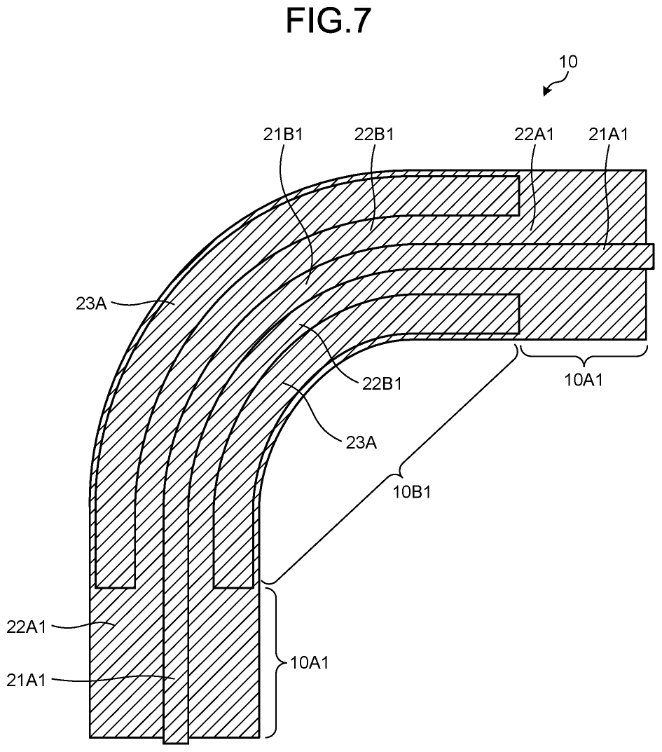

FIG. 7 is a plan view of the optical waveguide element 10 according to the second embodiment in which the upper cladding 12A is omitted. The optical waveguide element 10 according to the second embodiment illustrated in FIG. 7 is a bent waveguide. The bent waveguide is a Si waveguide in which the core 11 is made of silicon, the upper cladding 12A is made of SiO₂, and the lower cladding 12B is made of air or Si, such as SiN.

In the Si waveguide, an optical refractive index difference is large, so that optical confinement is high and it is possible to realize a bent waveguide with a low loss even with a small R, that is, it is possible to reduce a size of the device.

The optical waveguide element 10 illustrated in FIG. 7 includes, along a traveling direction of signal light, a first rib waveguide 10A1 that is arranged on a front stage, a second rib waveguide 10B1 that is optically coupled with the first rib waveguide 10A, and the first rib waveguide 10A1 that is arranged on a rear stage and that is optically coupled with the second rib waveguide 10B1.

The core 11 of the first rib waveguide 10A1 on the front stage includes a first main rib 21A1 and first slabs 22A1. The first main rib 21A1 is a waveguide in which the signal light propagates. The first slabs 22A1 are formed on both sides of the first main rib 21A1, and have smaller thicknesses than a thickness of the first main rib 21A1. Further, the first slabs 22A1 are waveguides in which the slab mode of the signal light propagates. Meanwhile, the first rib waveguide 10A1 on the front stage is illustrated as an example, but the first rib waveguide 10A1 on the rear stage has the same configuration, and therefore, the same components are denoted by the same reference symbols, and explanation of the same configuration and operation will be omitted.

The core 11 of the second rib waveguide 10B1 includes a curved second main rib 21B1, curved second slabs 22B1, and curved side ribs 23A. The curved second main rib 21B1 is a waveguide in which the signal light propagates. The curved second slabs 22B1 are formed on both sides of the curved second main rib 21B1, and have smaller thicknesses than the curved second main rib 21B1. Further, the curved second slabs 22B1 are waveguides in which the slab mode of the signal light propagates.

The curved side ribs 23A are formed on both sides of the curved second slabs 22B1, and have larger thicknesses than the curved second slabs 22B1. Further, each of the curved side ribs 23A is a waveguide to which the slab mode propagating in the curved second slabs 22B1 transition. A waveguide width of each of the curved side ribs 23A is set to be larger than a waveguide width of the curved second main rib 21B1.

In other words, the signal light is discontinued between the first rib waveguide 10A1 and the second rib waveguide 10B1. Therefore, the slab mode that propagates in the second slabs 22B1 transition to the side ribs 23A in accordance with travel of the signal light between the first rib waveguide 10A1 and the second rib waveguide 10B1. As a result, only the slab mode is scattered and eliminated due to transition of the slab mode to the side ribs 23A.

In the optical waveguide element 10 according to the second embodiment, even when the curved shapes are adopted, the slab mode transitions to the curved side ribs 23A, so that it is possible to prevent an influence of the slab mode on the signal light and prevent degradation of the signal quality due to a mode interference.

### Third Embodiment

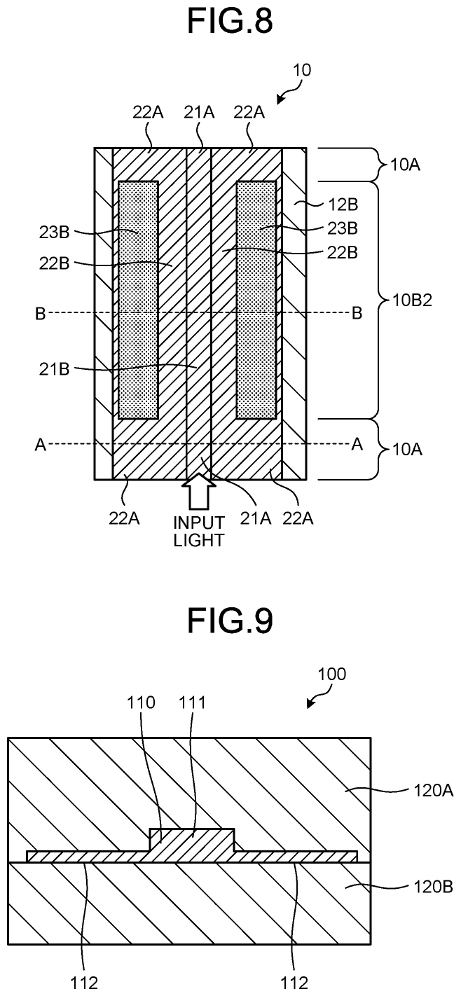

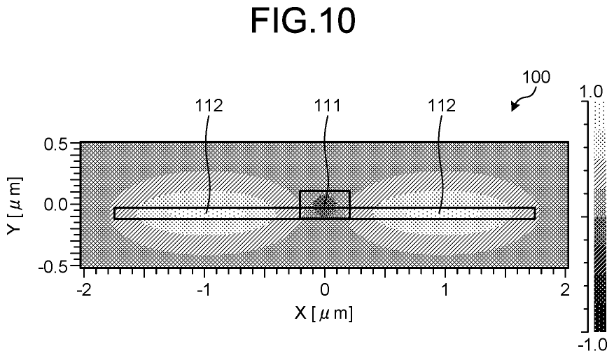

FIG. 8 is a plan view of the optical waveguide element 10 according to the third embodiment in which the upper cladding 12A is omitted. Meanwhile, the same components as those of the optical waveguide element 10 of the first embodiment are denoted by the same reference symbols, and explanation of the same configuration and operation will be omitted.

The optical waveguide element 10 according to the third embodiment is different from the optical waveguide element 10 according to the first embodiment in that side ribs 23B in a second rib waveguide 10B2 are subjected to doping.

By performing doping on only the side ribs 23B, it is possible to eliminate the slab mode that has transitioned to the side ribs 23B, and eliminate the slab mode with high efficiency.

With respect to the slab mode that has transitioned to the side ribs 23B, optical confinement in the core 11 is increased as compared to the slab mode, so that it is possible to apply a doping process that is used in a collectively integrated modulator or the like. As a result, it is possible to eliminate the slab mode by performing a simple process.

At least a part of the core of the side ribs 23B of the optical waveguide element 10 according to the third embodiment is subjected to doping. As illustrated in FIG. 6, in the slab mode, electric fields are locally present in the side ribs 23B, so that it is possible to effectively absorb light by doping in this portion. As a result, it is possible to eliminate the slab mode with high efficiency by eliminating the slab mode that has transitioned to the side ribs 23B.

According to one aspect, it is possible to eliminate the slab mode.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical waveguide element comprising:
a core that is formed on a substrate;
a cladding that covers the core;
a first rib waveguide that is arranged along a traveling direction of signal light; and
a second rib waveguide that is arranged along the traveling direction of the signal light and that is optically coupled with the first rib waveguide, wherein
the core of the first rib waveguide includes
a first main rib in which the signal light propagates; and
a first slab that has a smaller thickness than a thickness of the first main rib and in which a slab mode of the signal light propagates,
the core of the second rib waveguide includes
a second main rib that is optically coupled with the first main rib and in which the signal light propagates;
a second slab that has a smaller thickness than a thickness of the second main rib, that is optically coupled with the first slab, and in which the slab mode propagates; and
a side rib that is formed on one end of the second slab and that has a larger thickness than the thickness of the second slab, and
the slab mode propagates through the second slab transitions to the side rib in accordance with travel of the signal light that propagates in the first main rib of the first rib waveguide and the second main rib of the second rib waveguide.

2. The optical waveguide element according to claim 1, wherein the side rib is formed on one end of the second slab that is formed on at least one of both sides of the second main rib.

3. The optical waveguide element according to claim 1, wherein a waveguide width of the side rib is set to be larger than a waveguide width of the second main rib.

4. The optical waveguide element according to claim 1, wherein at least a part of a core of the side rib is subjected to doping.

5. The optical waveguide element according to claim 1, wherein
the core is made of silicon, and
the cladding is made of a material including SiO₂.

6. An optical communication apparatus comprising:
a processor that performs signal processing on an electric signal;
a light source that generates light;
a communication device that performs communication using the electric signal and the light; and
an optical waveguide element in which the light propagates, wherein
the optical waveguide element includes
a core that is formed on a substrate;
a cladding that covers the core;
a first rib waveguide that is arranged along a traveling direction of signal light; and
a second rib waveguide that is arranged along the traveling direction of the signal light and that is optically coupled with the first rib waveguide,
the core of the first rib waveguide includes
a first main rib in which the signal light propagates; and
a first slab that has a smaller thickness than a thickness of the first main rib and in which a slab mode of the signal light propagates,
the core of the second rib waveguide includes
a second main rib that is optically coupled with the first main rib and in which the signal light propagates;
a second slab that has a smaller thickness than a thickness of the second main rib, that is optically coupled with the first slab, and in which the slab mode propagates; and
a side rib that is formed on one end of the second slab and that has a larger thickness than the thickness of the second slab, and
the slab mode propagates through the second slab transitions to the side rib in accordance with travel of the signal light that propagates in the first main rib of the first rib waveguide and the second main rib of the second rib waveguide.

7. A method of eliminating a slab mode in an optical waveguide element that includes:
a core that is formed on a substrate;
a cladding that covers the core;
a first rib waveguide that is arranged along a traveling direction of signal light; and
a second rib waveguide that is arranged along the traveling direction of the signal light and that is optically coupled with the first rib waveguide, wherein
the core of the first rib waveguide includes
a first main rib in which the signal light propagates; and
a first slab that has a smaller thickness than a thickness of the first main rib and in which a slab mode of the signal light propagates,
the core of the second rib waveguide includes
a second main rib that is optically coupled with the first main rib and in which the signal light propagates;
a second slab that has a smaller thickness than a thickness of the second main rib, that is optically coupled with the first slab, and in which the slab mode propagates; and
a side rib that is formed on one end of the second slab and that has a larger thickness than the thickness of the second slab, and
the slab mode propagates through the second slab transitions to the side rib in accordance with travel of the signal light that propagates in the first main rib of the first rib waveguide and the second main rib of the second rib waveguide.
